(19) United States
(12) Patent Application Publication
(10) Pub. No.: US 2023/0004792 A1
(43) Pub. Date: Jan. 5, 2023

(54) AUTOMATICALLY STRUCTURING USER INTERACTION TRAILS FOR KNOWLEDGE EXPANSION IN A KNOWLEDGE GRAPH

(71) Applicant: INTERNATIONAL BUSINESS MACHINES CORPORATION, Armonk, NY (US)

(72) Inventors: Rafael Rossi de Mello Brandao, Rio de Janeiro (BR); Marcio Ferreira Moreno, Rio de Janeiro (BR); Guilherme Augusto Ferreira Lima, Sao Paulo (BR); Renato Fontoura de Gusmao Cerqueira, Rio de Janeiro (BR)

(21) Appl. No.: 17/367,598

(22) Filed: Jul. 5, 2021

(51) Int. Cl. G06N 3/08; G06N 3/04; G06N 5/02

(52) U.S. Cl. CPC G06N 3/08; G06N 3/04; G06N 5/02

(57) ABSTRACT

A method and system of creating a knowledge graph includes capturing information of a user interacting with given data, as user interaction data. The user interaction data is structured as a trail of actions over time. An ontology for a domain related to the user interaction data is received. Each action of the trail of actions is matched onto entities of the ontology. The knowledge graph is created based on the ontology having the matched actions.

### BACKGROUND

### Technical Field

The present disclosure generally relates to computers, and more particularly, to automatically capturing user interaction in a knowledge graph.

### Description of the Related Art

Today, representing users' creative and interpretive processes may be useful to identify problems and solutions associated with interactive decision-making processes of domain experts. Generally, these processes are related to the interaction of users with some content, such as text, video, audio, images, etc., collectively referred to herein as data, and structuring users' tacit and explicit knowledge. Tracking such process can generate a representation of users' trails. However, known representations are generally not well structured from a knowledge engineering perspective to facilitate machine learning by a computing device. Considering highly immersive environments with interaction through multiple modalities, tracking this knowledge becomes even more complex.

On one hand, cognitive agents have been increasingly used to support decision-making practices, which may involve knowledge-intensive activities and critical thinking. On the other hand, these systems may demand an overly complex design and implementation given the lack of knowledge representations capable of describing steps of creative processes, including rich relationships between symbolic and non-symbolic data.

Currently, there are two main bottlenecks in the knowledge engineering process related to structuring and extracting patterns from complex user activities. The first concerns the lack of consistent representations that focus on connecting heterogeneous data. Ideally, a representation should provide mechanisms for facilitating the structuring and processing of user input, data sources and knowledge entities as salient information. The second bottleneck comes from the difficulty of managing, populating, and expanding such datasets with complex user activities representations. In addition, extracting information and patterns from this type of data may pose a challenge as well.

Current solutions for representing complex user activities, knowledge extraction and knowledge expansion typically focus on specific parts of the Knowledge Engineering process. Generally, known solutions either focus on inferring new concepts from existing symbolic representations or exploit user queries on knowledge-based systems to promote the expansion. Other solutions focus on capturing user interaction without contextual information or without a knowledge representation that is amenable to structuring and information extraction.

### SUMMARY

According to various exemplary embodiments, a computing device, a non-transitory computer readable storage medium, and a method are provided to automatically provide a knowledge graph. Information of a user interacting with given data is captured as user interaction data. The user interaction data is structured as a trail of actions over time. An ontology is received for a domain related to the user interaction data. Each action of the trail of actions is matched onto entities of the ontology. The knowledge graph is created based on the ontology having the matched actions.

In one embodiment, the contextual information of the interaction data includes at least one of audio or video of the user interacting with the given data.

In one embodiment, a facial expression of the user is determined for at least one action of the trail of actions.

In one embodiment, the user interaction data is continuously captured. The knowledge graph is iteratively updated based on the continuously captured interaction data.

In one embodiment, the structured interaction data includes one or more nested hierarchies of the trails of actions.

In one embodiment, one or more actions of the matched trail of actions are adjusted upon receiving instructions from a domain expert.

In one embodiment, the created knowledge graph is used as a corpus of data for machine learning to create an improved trail of actions for the ontology.

In one embodiment, the machine learning is based on a graph neural network (GNN).

In one embodiment, machine learning is used to create one or more new entities in the knowledge graph.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is an example architecture of a system for automatically structuring user interaction trails for knowledge expansion in a knowledge graph, consistent with an illustrative embodiment.

FIG. 2 is an example block diagram of aspects of the knowledge expansion engine of FIG. 1, consistent with an illustrative embodiment.

FIG. 3 is a conceptual block diagram of a use case related to seismic cube exploration, consistent with an illustrative embodiment.

FIG. 4 is a conceptual block diagram of a use case related to machine learning model design, consistent with an illustrative embodiment.

FIG. 5 describes a knowledge structure process, consistent with an illustrative embodiment.

FIG. 6 describes a trail-based knowledge expansion process, consistent with an illustrative embodiment.

FIG. 7 is a functional block diagram illustration of a particularly configured computer hardware platform that can be used to implement the server of FIG. 1.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

In discussing the present technology, it may be helpful to describe various salient terms. As used herein linked data relates to an approach to structured data representation that manifests as a web of data. It enables transparent access to data (e.g., by way of hyperlinks) thereby enabling integration of data across disparate data sources as well as providing platform-independent data connectivity across new and existing enterprise solutions.

As used herein, an ontology is a collection of entity type and entity relationship type definitions associated with a realm of discourse (e.g., a scientific domain). Ontologies can be constructed using linked data principles and may be loosely-coupled and shareable. Ontologies provide a description of a system as well as system relationship types that provide reasoning and inference performed by both humans and machines.

As used herein, a knowledge graph relates to a semantic knowledge base organized as a graph where relationships between facts are formally described by an ontology. In a knowledge graph, each data item is referred to herein as a node or vertex, and are typically represented by circles. Each node is connected by “edges” represented by lines interconnecting the nodes. By virtue of using graphs (e.g., instead of tables or other disparate type of representation), it is possible to capture the fundamentally “messy” nature of data in a way that is easier to understand and that provides sufficient structure for a computer to be able to efficiently process the data. For example, both tabular data and tree like data can be captured efficiently by graphs. Images and texts can be represented. In some instances, audio and/or video can be played upon a selection of a node. Accordingly, data is presented not in an isolated way, but rather in relation to other data, which makes it easier to understand and digest. Knowledge graphs are created by describing entities (i.e., nodes in the graph, which can be conceptual knowledge or data) and entity relationship types using sentences that are deployed using linked data principles.

The present disclosure generally relates to methods and systems of automatically structuring user interaction trails for knowledge expansion in such knowledge graphs. Inferring human interpretation and knowledge in such a representation in these processes captured in knowledge graphs are salient to improve the design of systems that support decision-making, as well as finetuning processes to improve quality and efficiency. In one aspect, the present disclosure applies high-level conceptual components in a knowledge representation to characterize users' interpretive trails. The teachings herein facilitate the computerized characterization of actions taken by a user (e.g., domain expert) with respect to a predetermined ontology related to a domain. Each of the actions, sometimes referred to herein as interaction activity or interaction data, is captured in a stream of events over time. The user interaction data is structured as a trail of actions. Each element of the trail is mapped onto nodes of the predetermined ontology.

Applicants have determined that capturing these user interactions, as a user interacts with various forms of data, such as text, audio, video, graph, etc., is useful in identifying possible problems in the trail of actions, thereby facilitating optimization of the trail. In one aspect users' intent and reasoning is captured during these activities, which may involve multimodal data as well as the user emotions, experiences, insights, intuition, and observations related to the corresponding action taken.

The proposed representation takes advantage of combining experts' interaction with data segments (e.g., sentences of a text document, fragments of images, segments of seismic data, frames of a video file, etc.,) with knowledge representations (conceptual entities in an ontology that can be reasoned upon). The knowledge representations discussed herein are capable of not only capturing user interaction data, but also structuring the user interaction as a trail of actions in time. Each of the actions is mapped to elements of an ontology for a domain (e.g., field of study or system).

Knowledge graphs are not only created but also capable of being expanded and adjusted based on the computation of variations of different user activities. The structuring of complex user activities and knowledge intensive processes in the proposed representation system promotes a systematic presentation and consumption of knowledge. Furthermore, drawing on such representation pattern detection and information extraction pipelines can provide knowledge base expansion based on different learning strategies, including symbolic reasoning (e.g. rule based facts), non-symbolic (e.g. GNN, GANS or other ML predictive approach) or a combined neuro-symbolic approach discussed in more detail below. By virtue of the teachings herein, it is possible to create new coherent complex user data that can be further curated by users. For example, a multi-user dashboard GUI can allow visual interaction with the graph and enable users to explore trails and expansion strategies, as well as correct any aspect of the graph they deem should be corrected. The newly created knowledge data provided by the selected learning strategies and executed learning pipelines is used for maximizing the number of instances in the knowledge base, thereby facilitating new insights for users and providing a corpus of learning data for machine learning algorithms. Such data maximizes not only the instance of entities (e.g., a-box expansion), but also the classes in the ontology (e.g., t-box expansion). The techniques described herein may be implemented in a number of ways. Example implementations are provided below with reference to the following figures.

### Example Architecture

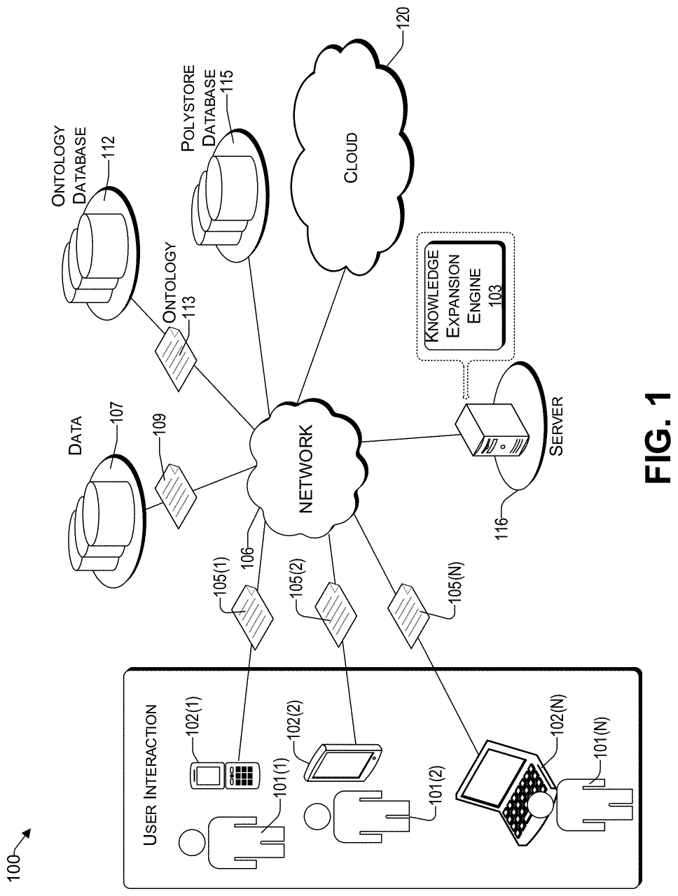

FIG. 1 is an example architecture 100 of a system for automatically structuring user interaction trails for knowledge expansion in a knowledge graph, consistent with an illustrative embodiment. Architecture 100 may include one or more users 101(1) to 101(N), sometimes referred to herein as domain experts, who can interact individually or collaboratively with processing data 109 from one or more data sources related to their respective domain, collectively represented by data source 107. By way of example and not by way of limitation, the domain may relate to rocket science and the data 109 being processed relates to an upcoming rocket launch. In various embodiments, the data 109 may include, textual, visual, video, graph, etc., information. Each user 101(1) to 101(N) can interact with the data 109 to learn from it, make adjustments, and base their decisions on the data 109. Each of the interactions between a user 101(1) to 101(N) and the data 109 is recorded as electronic data packages 105(1) to 105(N), which may include, without limitation, what portion of the data 109 is being processed, what decisions are being made, amount of time spent on specific portions of the data 109, changes being made to any portion of the data, etc., In some embodiments, higher-level information is recorded in the electronic data packages 105(1) to 105(N) to extract context, including facial expressions of the user, user intent, user intent, etc., discussed in more detail later.

There is a network that 106 allows the various user devices 102(1) to 101(N) to communicate with the data repository 107, a knowledge expansion server 116, and/or each other. The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet, that provides various ancillary services, such as communication with various databases, the Internet, and the cloud 120.

For discussion purposes, different user/computing devices (e.g., 102(1) to 102(N)) appear in the drawing, to represent some examples of the client devices that may be used by a user (e.g., 101(1) to 102(N)) to communicate over the network 106. Today, user devices typically take the form of portable handsets, smart-phones, tablet computers, personal digital assistants (PDAs), and smart watches, although they may be implemented in other form factors, including consumer, medical, and business electronic devices.

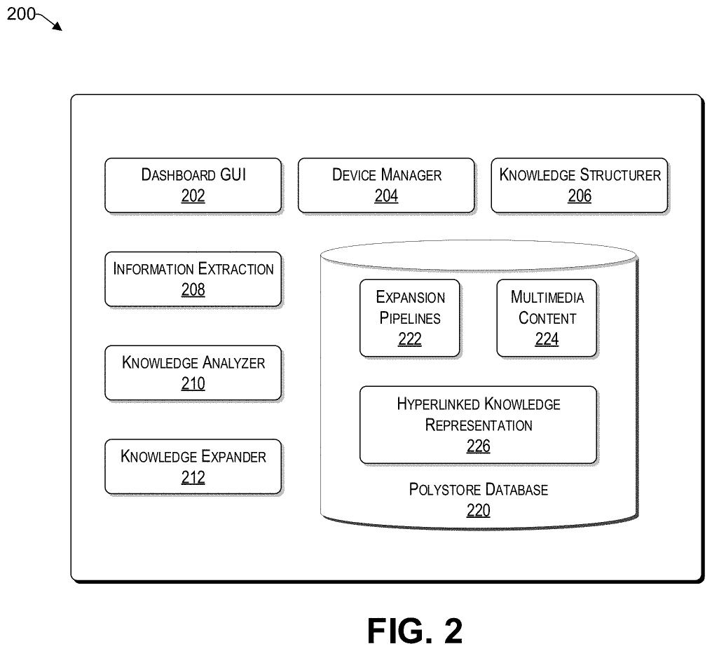

In one embodiment, there is an ontology database 112 that is configured to store one or more ontologies that are related to a particular realm of discourse of the domain experts 101(1) to 101(N). There is a knowledge expansion engine 103 running on a server 116 that is configured to receive an ontology 113 from the ontology database 112 to glean therefrom a network of entities for a realm of discourse, sometimes simply referred to herein as a domain. The knowledge expansion engine 103 captures user interaction with the data 109 by way of the data packages 105(1) to 105(N). In various embodiments, the data packages 105(1) to 105(N), collectively referred to herein as user interaction data, may be received continuously (as the information becomes available) or upon a trigger event (e.g., predetermined time intervals or upon the user indicating that certain activities with respect to the data 109 have been completed). The knowledge expansion engine 103 captures the user interaction data 105(1) to 105(N) as a stream of events in time. The knowledge expansion engine 103 structures the user interaction data 105(1) to 105(N) as a trail of actions (interactions with the data over time). In one embodiment, the knowledge expansion engine is able to provide a semantic layer to the interaction data 105(1) to 105(N), providing meaning to each interaction, including industry domain information. There may be a polystore database 115 that may be used as a repository for the knowledge expansion engine. These concepts are explained in more detail below in the context of the discussion of FIGS. 2 to 4.

While the one or more data sources 107, ontology database 112, and the server 116 are illustrated by way of example to be on different platforms, it will be understood that, in different embodiments, these platforms may be combined in different combinations. In other embodiments, one or more of these computing platforms may be implemented by virtual computing devices in the form of virtual machines or software containers that are hosted in the cloud 120, thereby providing an elastic architecture for processing and storage. The cloud is discussed in more detail later.

### Example Block Diagram of Knowledge Expansion Engine

FIG. 2 is an example block diagram 200 of the knowledge expansion engine 103 of FIG. 1, consistent with an illustrative embodiment. For discussion purposes, block diagram 200 is discussed with reference to FIG. 1.

The system may include a dashboard graphical user interface (GUI) module 202 that is operative to provide one or more users 102(1) to 102(N) to interact with the data 109. In various embodiments, the dashboard GUI 202 may be of the knowledge expansion engine 103 or user device (e.g., 102(1) to 102(N). There may be a device manager 204 that operative to handle all available sensors that capture user activities (i.e., interaction with the data 109) as well as the context of each interaction. In various embodiments, information from a keypad, microphone, haptic element, touch sensitive display screen, mouse, stylus, motion sensor, gyroscope, etc., of the user device (e.g., 102(2)) may be used as a source of this information.

The information extraction module 208 is operative to extract relevant information embedded in the digital content 105(1) to 105(N). For example, every selection, annotation, explanation, etc., is interpreted by the extraction module 208. In some embodiments, the audio signals harvested by the one or more sensors are also used to convert any captured speech to text. The information extraction module 208 may use natural language processing (NLP) to process the raw natural language content of the verbal queues of a user (e.g., 102(1)). The knowledge expansion engine 103 can perform speech recognition to determine the textual representation thereof. In natural speech, there may not be discernable pauses between successive words. To that end, speech segmentation may be performed to separate the words into meaningful sentences.

In one embodiment, concept expansion, such as the IBM Watson Concept Expansion™ can be used to identify the concept cues in a received in an electronic data package (e.g., 105(1) reflecting the interaction interactions between a user and the data 109, as well as the context information to determine the intent thereof). In this regard, large sets of unstructured sets of data may be provided to the information extraction module 208 during a training stage, such that it can learn therefrom. The large sets of unstructured data may relate to prior user interactions with data that were successfully interpreted by the information extraction module 208, which now acts as a corpus of data to learn from. Such concept expansion enables the creation of a specialized dictionary for the cognitive application of identifying the subject matter and scope of each user interaction, collectively referred to herein as the “intent” of the interaction. Concept expansion enables the information extraction module 208 to build a specialized dictionary for the cognitive application of interacting with the electronic data package from the user (e.g., 105(1)). Accordingly, by virtue of the information extraction module 208, the knowledge expansion engine 103 can correctly understand industry specific terminology, local euphemisms, and colloquial terms that may be specific to a domain.

In one embodiment, there is a knowledge structurer module 206 that is operative to structure the captured user interaction data and as a trail of actions (e.g., events over time). The goal is to have user interaction data connected and aligned with specialized ontologies. The alignment enables the mapping of low-level interaction events (e.g., streaming data with timestamps) to a high-level discovery-process that is described by the domain ontology.

There may be a polystore database 220 that is operative to decide which module will be used to store each type of content. The polystore database 220 provides the possibility of storing information on different storage solutions in parallel. For instance, the system may use a mongoDB object database to store files and binary data, and a Jena triplestore for facts. The polystore provides an abstraction for the system that may be agnostic to the actual storage solutions. Generally a multimedia content module 224 is used to store all user content. In one embodiment, the intelligent mechanisms that enable knowledge expansion are stored in the learning pipelines 222, whereas the structured user interactions (i.e., trails) are stored in the hyperlinked knowledge representation module 226.

In one embodiment, there is a knowledge analyzer module 210 that is operative to process the graph representation from the polystore database 220 (i.e., knowledge graph, data database, etc.), as well as identify learning strategies for expanding the knowledge graph based on existing trail-based structures (i.e., recorded trails for the subject domain).

In one embodiment, there is a knowledge expander 212 that is operative to apply the strategy selected by the knowledge analyzer 210 to create new entities in the hyperlinked knowledge representation 109 (e.g., graph). The knowledge analyzer module 210 identifies viable strategies for expanding the KG (i.e. via ML algorithms, rule-based inference, etc.). The knowledge expander module 212 is in charge of actually executing these learning strategies and injecting the result in the KG for further inspection and curation.

### Example Use Case Scenarios

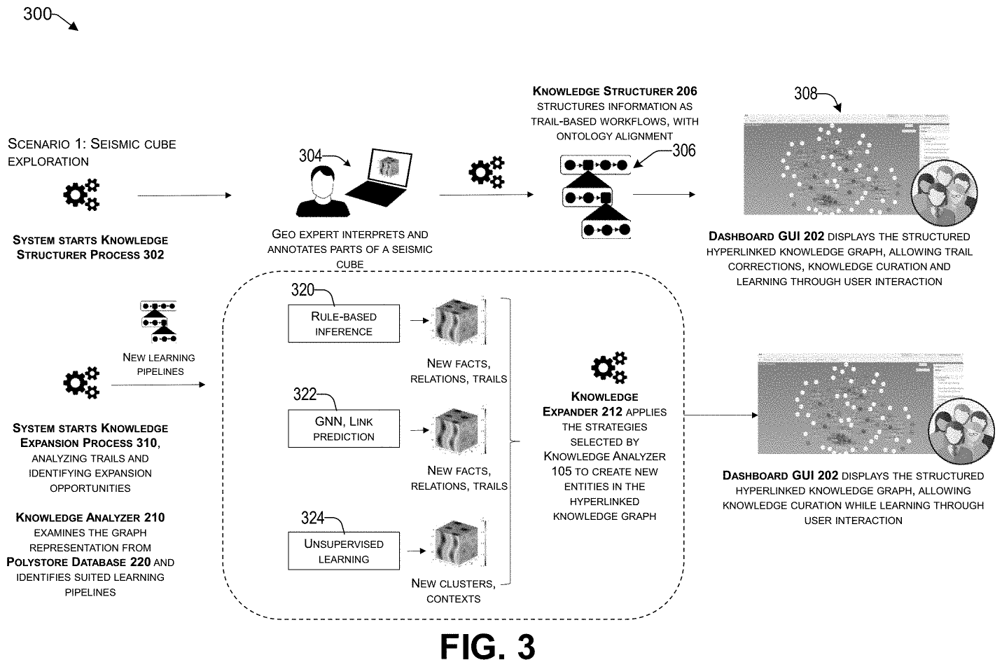

The concepts discussed herein may be better appreciated in view of some use case scenarios. Consider for example a geologist (e.g., domain expert) exploring seismic images (e.g., seismic cube) from disparate sources. In this regard, FIG. 3 provides a conceptual block diagram 300 of a use case related to seismic cube exploration, consistent with an illustrative embodiment. For discussion purposes, FIG. 3 is discussed below with reference to FIG. 1.

Upon a trigger event, the knowledge expansion engine 103 starts the knowledge structure process (302). The domain expert receives data related to seismic activity. For example, the domain expert interprets and annotates parts of a seismic cube received from a data source 107. Additionally, the domain expert can review various sources of data to identify geological factors and make decisions based on their review of the data. For example, upon identifying certain patterns in the seismic cube, the domain expert takes one or more actions by annotating each relevant segment of the data with his/her findings (304). These findings may be entered into a dashboard GUI. Additional context data may be harvested by various sensors of the user device.

The information extraction module 208 receives the electronic data package including the interaction data as well as the context data. The knowledge structurer module 206 structures the received electronic data and context data as a trail-based workflow (306). Stated differently, the received user interaction data and its corresponding context data is structured as a trail of actions. Each action in the trail is aligned onto entities of an ontology that describes the actions of the domain expert. For example, each of the actions is mapped to entities of an ontology for a domain (e.g., actions related to the analysis of specific subsurface structures in the domain of geology). In some embodiments, the actions may be hierarchical and nested, where a general action can be divided into trails of sub-actions at different levels of nesting. In one embodiment, a domain expert (e.g., the same domain expert performing the actions or another authorized user) can adjust the mapping after the initial mapping of the knowledge structurer 206.

The trail aligned to the ontology is used to generate a (e.g., hyperlinked) knowledge graph, which can be displayed on a user interface (e.g., GUI 202) (308). The knowledge graph can be navigable and nested. For example, a user can select a node to go down to a more fine grain level of resolution of actions performed. The knowledge expansion engine 103 can compare various trails to determine which actions and sequence of actions are more effective with respect to the ontology. In this regard, the knowledge expansion engine 103 can make adjustments to elements (e.g., actions) of the trail, as discussed in more detail below in the context of the knowledge expansion process 310.

During a knowledge expansion process 310, one or more available trails that are part of the knowledge graph are analyzed and opportunities for knowledge expansion are provided by the knowledge analyzer module 210. For example, the knowledge analyzer 210 traverses the knowledge graph representation provided by the polystore database 220 and identifies one or more appropriate learning pipelines. As used herein, learning pipelines are the workflows that, if executed, create further instances (e.g., a-box expansion) or even new classes and relations (e.g., t-box expansion). These pipelines may involve ML tasks, but also other types of learning (e.g., rule-based inference, or other numerical processing workflows). In various embodiments, rule-based inference 320, graph neural network (GNN) for link prediction 322, and/or unsupervised learning 324 can be used to generate new facts, relations, and trails (e.g., a-box and t-box expansion). In this way, the knowledge expander module 212 can apply one or more of these strategies selected by the knowledge analyzer 210 to create new entities (e.g., nodes) in the (e.g., hyperlinked) knowledge graph. The knowledge expansion engine 103 can then display the structured (e.g., hyperlinked) knowledge graph, thereby facilitating knowledge curation by users and or by way of machine learning, while continuously learning through new user interaction. In one example, the criteria to select the appropriate strategy depends on the problem the user is addressing in his/her discovery-process. It is assumed this information will be modeled in the injected ontology. For instance, in the geoscience use case, the expert is trying to classify and annotate images. In this case, the system will try to create workflows that can ingest images and provide a classifier for parts of the seismic image.

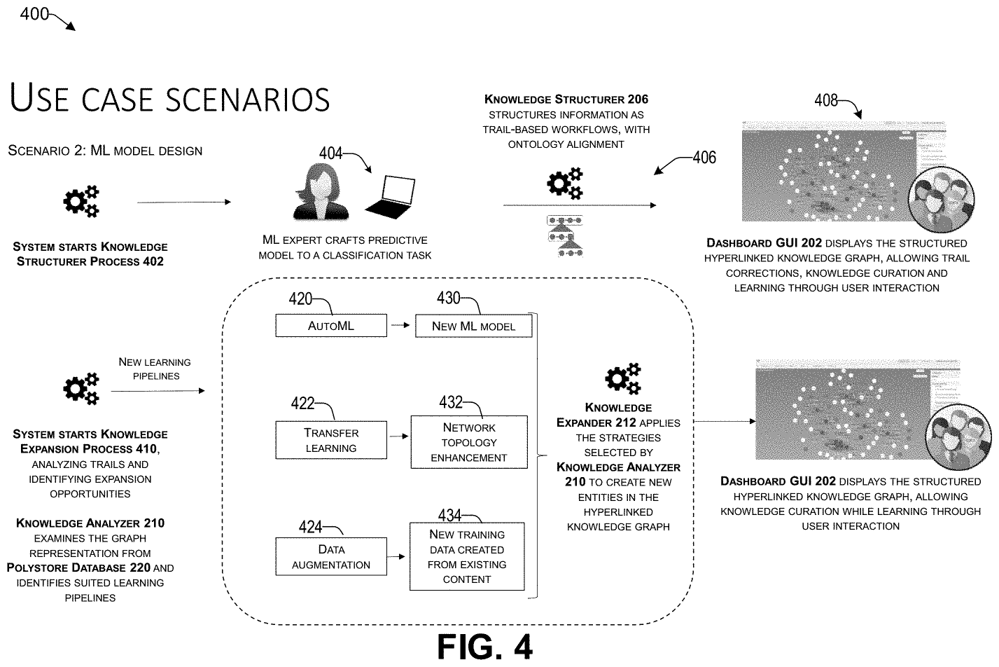

Reference now is made to FIG. 4, which provides a conceptual block diagram 400 of a use case related to machine learning (ML) model design, consistent with an illustrative embodiment. Again, FIG. 4 is discussed below with reference to FIG. 1 for clarity. Since the overall architecture 400 is similar to that of FIG. 3 discussed above, it will not be discussed in substantial detail for brevity, while it will be understood that similar actions can apply.

Upon a trigger event, the knowledge expansion engine 103 starts the knowledge structure process (402). The domain (i.e., machine learning in the present example) expert receives raw data and creates a predictive model with respect to a classification task (404). The knowledge structurer module 206 structures the received electronic data and context data as a trail-based workflow (406). Each action in the trail is aligned onto entities of an ontology that governs the actions of the domain expert.

The trail aligned to the ontology is used to generate a (e.g., hyperlinked) knowledge graph, which can be displayed on a user interface (e.g., GUI 202) (408). As in the example of FIG. 3, the knowledge expansion engine 103 can compare various trails to determine which actions and sequence of actions are more effective with respect to the ontology.

During a knowledge expansion process 410, where new learning pipelines are developed, one or more available trails are analyzed and the knowledge graph is traversed for identifying opportunities for knowledge expansion by the knowledge analyzer module 210. For example, the knowledge analyzer 210 traverses the knowledge graph representation provided by the polystore database 220 and identifies one or more appropriate learning pipelines. Automatic machine learning 420 may be used to develop new ML models 430. For example, the corpus of data to learn from (e.g., training data) can be both trails and other data represented in the knowledge graph. If multiple trails are not provided, in one embodiment, one shot machine learning may be performed. Alternatively, or in addition, transfer learning 422 may be performed by the knowledge expansion engine 103 to provide a network topology (e.g., structure of neural networks) enhancement 432, and/or data augmentation 424 to create new training data from existing content 434. In this way, the knowledge expander module 212 can apply one or more of these strategies selected by the knowledge analyzer 210 to create new entities in the in the (e.g., hyperlinked) knowledge graph. The knowledge expansion engine 103 can then display the structured (e.g., hyperlinked) knowledge graph, thereby facilitating knowledge curation by users and/or by way of machine learning, while continuously learning through new user interaction.

### Example Processes

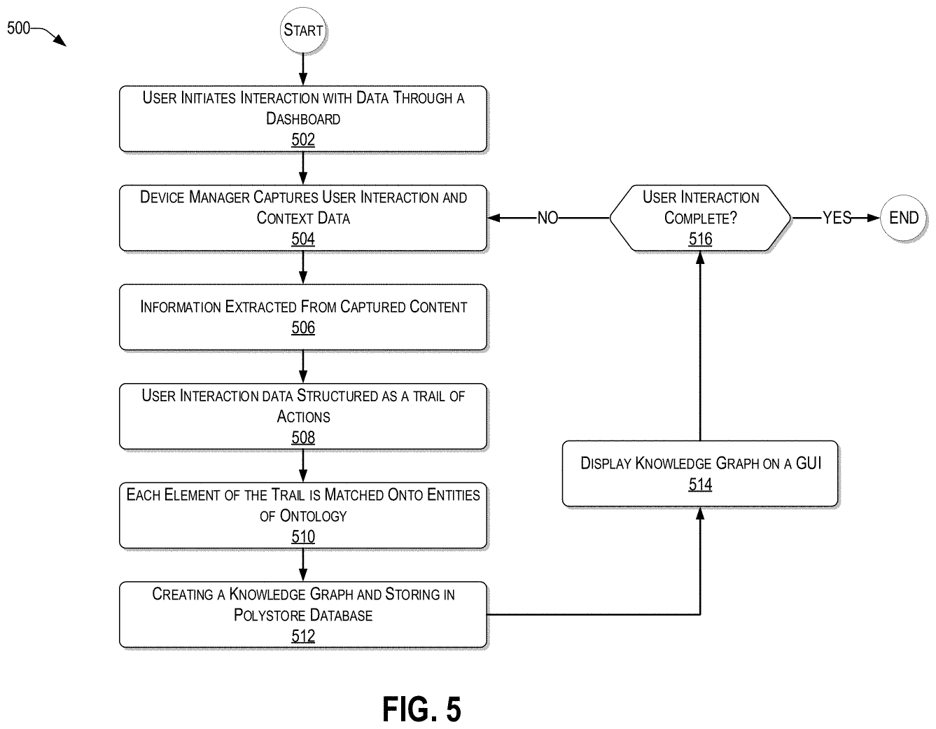

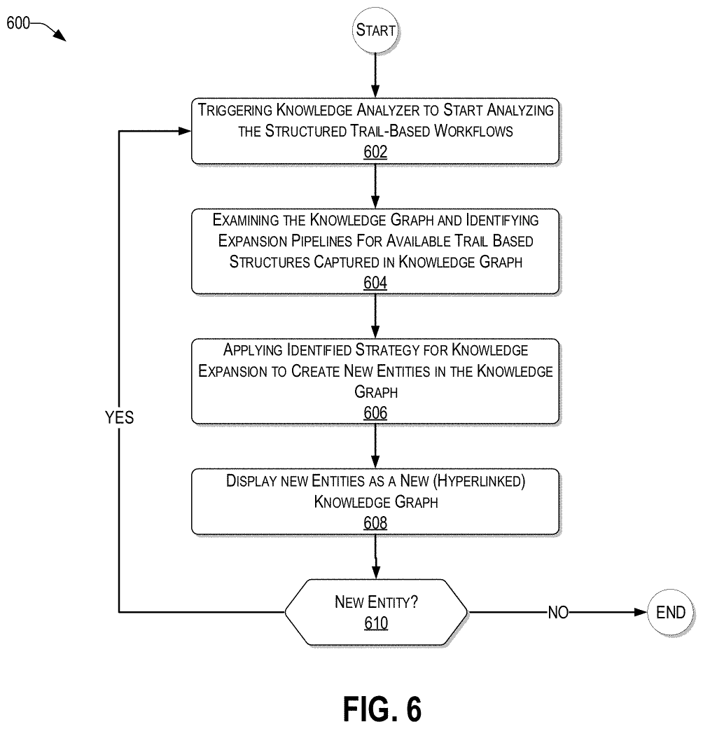

With the foregoing overview of the architecture 100, example block diagram 200 of the knowledge expansion engine 103, and example use cases 300 and 400, it may be helpful now to consider a high-level discussion of example processes. To that end, FIGS. 5 and 6 present illustrative processes 500 and 600 for automatically structuring user interaction trails for knowledge expansion in knowledge graphs. More specifically, FIG. 5 describes a knowledge structure process and FIG. 6 describes a subsequent trail-based knowledge expansion process, consistent with an illustrative embodiment.

Processes 500 and 600 are each illustrated as a collection of blocks in a process, representing a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or performed in parallel to implement the process. For discussion purposes, the processes 500 and 600 are described with reference to the architectures 100 and 200 of FIGS. 1 and 2, respectively.

At block 502, a user (e.g., domain expert) initiates interaction with data 109 by way of a dashboard GUI (e.g., 202). In response, at block 504, the device manager 204 starts capturing the user interaction with the data 109 by way of electronic data packages (e.g., 105(1) to 105(N)) harvested through various sensors, as discussed herein. In some embodiments, context of one or more user interactions are captured in the electronic data packages additionally.

At block 506, the information extraction module 208 of the knowledge expansion engine 103 extracts (e.g., interprets) information from the captured user interaction (and the context information if available, such as facial expression, user intent etc.,). For example, any selection, user input, video content, audio content, context information, annotation, explanation, etc., is interpreted by the extraction module 208 using one or more machine learning/artificial intelligence techniques, as discussed herein.

At block 508, the information extracted from the captured content is structured as a trail of actions (e.g., interactions over time) by the knowledge structurer module 206. In one embodiment, facial expression, mood, etc., can be used as peripheral information that can be used to infer further the user intent.

At block 510, each of the trail of actions (which may also include the contextual information) is mapped onto a predetermined ontology 113, which may be received from an ontology database 112. Stated differently, the low-level events (e.g., actions) are aligned with high-level entities of the ontology by the knowledge structurer module 206.

At block 512, the knowledge representation module 226 creates a knowledge graph based on the matched ontology. In one embodiment, the knowledge graph is hyperlinked (i.e., has references to other graphs). The knowledge graph can be stored in the polystore database 220 for further processing.

At block 514, the knowledge graph can be displayed on a GUI. A user can make trail corrections or adjustments, as well as use the knowledge graph as a basis of learning and having an overview of the actions taken in relation to the overall ontology.

In one embodiment, the harvesting and updating of the knowledge graph is iterative in that the knowledge graph is continuously updated based on additionally harvested information (e.g., user interaction data and context data). In this regard, at block 516, the expansion knowledge engine 103 determines whether the user interaction is complete. For example, the knowledge expansion engine 103 may wait a predetermined time period or send a request to a GUI of the user device to determine the status of the interaction. Upon determining that the user interaction is complete (i.e., “YES” at determination block 516), the process ends. However, upon determining that the interaction is not complete (i.e., “NO” at determination block 516), the process returns to block 504, where the device manager 204 captures additional user interaction (and possibly context data), and the process continues iteratively.

Reference now is made to FIG. 6, which is a process flow related to a trail-based knowledge expansion, consistent with an illustrative embodiment. For example, the polystore database 220 may include many knowledge graphs capturing structured trail-based workflows (e.g., action of a trail matched onto entities of an ontology). In various embodiments, a (hyperlinked) graph can be structured to include multiple trails or each trail can be separated into a separate (e.g., hyperlinked) knowledge graph. At block 602, for each knowledge graph, the knowledge analyzer 210 of the knowledge expansion engine 103 retrieves and processes the structured trail-based workflows captured in the knowledge graph.

At block 604, the knowledge analyzer 210 traverses the knowledge graph and identifies learning pipelines for the available trails (e.g., user interactions with data that are mapped onto the ontology) captured and structured in the knowledge graph. The knowledge analyzer 210 determines appropriate learning pipeline(s), including data augmentation, symbolic reasoning, and/or other artificial learning strategies, including (without limitation) unsupervised learning, supervised learning, auto-ML, GAN, link prediction, etc., for the available trail-based structures.

At block 606, the knowledge expander module 212 applies the determined expansion strategy provided by the knowledge analyzer 210 and creates new entities in the knowledge graph.

At block 608, a new knowledge graph is provided on a GUI (e.g., 202) that includes the new entities. In one embodiment, the knowledge graph is hyperlinked.

At block 610, the knowledge expansion engine 103 determines whether a new trail is available. If not (i.e., “NO” at decision block 610), the process ends. However, if a new entity is available (i.e., “YES” at decision block 610), the process returns to block 602 to continue the iterative process.

### Example Computer Platform

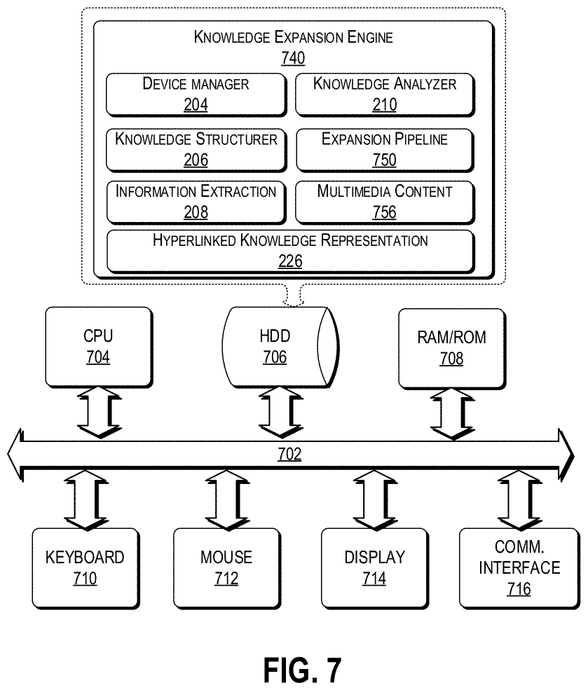

As discussed above, functions relating to automatically structuring user interaction trails for knowledge expansion in knowledge graphs, and other functions discussed herein, can be performed with the use of one or more computing devices connected for data communication via wireless or wired communication, as shown in FIG. 1. FIG. 7 is a functional block diagram illustration of a particularly configured computer hardware platform that can be used to implement the server 116 discussed in the context of FIG. 1.

The computer platform 700 may include a central processing unit (CPU) 704, a hard disk drive (HDD) 706, random access memory (RAM) and/or read only memory (ROM) 708, a keyboard 710, a mouse 712, a display 714, and a communication interface 716, which are connected to a system bus 702.

In one embodiment, the HDD 706, has capabilities that include storing a program that can execute various processes, such as the knowledge expansion engine 740, in a manner described herein. The knowledge expansion engine 740 may have various modules configured to perform different functions. For example, there may be a device manager module 204, a knowledge structurer module 206, an information extraction module 208, a knowledge analyzer module 210, an learning pipeline module 750, a multimedia content module 756, and/or a hyperlinked knowledge representation module 226, as discussed herein.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a network interface coupled to the processor to enable communication over a network;
a storage device for content and programming coupled to the processor;
an engine stored in the storage device, wherein an execution of the engine by the processor configures the user device to perform acts comprising:
capturing information of a user interacting with given data, as user interaction data;
structuring the user interaction data as a trail of actions over time;
receiving an ontology for a domain related to the user interaction data;
matching each action of the trail of actions onto entities of the ontology; and
creating a knowledge graph based on the ontology having the matched actions.

2. The computing device of claim 1, wherein the contextual information of the interaction data includes at least one of audio or video of the user interacting with the given data.

3. The computing device of claim 2, wherein the execution of the engine further configures the computing device to perform an act comprising determining a facial expression of the user for at least one action of the trail of actions.

4. The computing device of claim 1, wherein:
the user interaction data is continuously captured; and
the knowledge graph is iteratively updated based on the continuously captured interaction data.

5. The computing device of claim 1, wherein the execution of the engine further configures the computing device to perform acts comprising determining an intent of each captured user interaction by way of artificial intelligence.

6. The computing device of claim 1, wherein the structured interaction data includes one or more nested hierarchies of the trails of actions.

7. The computing device of claim 1, wherein the execution of the engine further configures the computing device to perform an additional act comprising adjusting one or more actions of the matched trail of actions upon receiving instructions from a domain expert.

8. The computing device of claim 1, wherein the execution of the engine further configures the computing device to perform an additional acts comprising using the created knowledge graph as a corpus of data for machine learning to create an improved trail of actions for the ontology.

9. The computing device of claim 8, wherein the machine learning is based on a graph neural network (GNN).

10. The computing device of claim 1, wherein the execution of the engine further configures the computing device to perform additional acts comprising using machine learning to create one or more new entities in the knowledge graph.

11. A non-transitory computer readable storage medium tangibly embodying a computer readable program code having computer readable instructions that, when executed, causes a computing device to carry out a method creating a knowledge graph, the method comprising:
capturing information of a user interacting with given data, as user interaction data;
structuring the user interaction data as a trail of actions over time;
receiving an ontology for a domain related to the user interaction data;
matching each action of the trail of actions onto entities of the ontology; and
creating the knowledge graph based on the ontology having the matched actions.

12. The non-transitory computer readable storage medium of claim 11, wherein the contextual information of the interaction data includes at least one of audio or video of the user interacting with the given data.

13. The non-transitory computer readable storage medium of claim 12, further comprising determining a facial expression of the user for at least one action of the trail of actions.

14. The non-transitory computer readable storage medium of claim 11, wherein:
the user interaction data is continuously captured; and
the knowledge graph is iteratively updated based on the continuously captured interaction data.

15. The non-transitory computer readable storage medium of claim 11, wherein the structured interaction data includes one or more nested hierarchies of the trails of actions.

16. The non-transitory computer readable storage medium of claim 11, further comprising adjusting one or more actions of the matched trail of actions upon receiving instructions from a domain expert.

17. The non-transitory computer readable storage medium of claim 11, further comprising using the created knowledge graph as a corpus of data for machine learning to create an improved trail of actions for the ontology.

18. The non-transitory computer readable storage medium of claim 11, wherein the machine learning is based on a graph neural network (GNN).

19. The non-transitory computer readable storage medium of claim 11, further comprising using machine learning to create one or more new entities in the knowledge graph.

20. A computer implemented method comprising:
capturing information of a user interacting with given data, as user interaction data;
structuring the user interaction data as a trail of actions over time;
receiving an ontology for a domain related to the user interaction data;
matching each action of the trail of actions onto entities of the ontology; and
creating the knowledge graph based on the ontology having the matched actions.
